(19) United States
(12) Patent Application Publication
(10) Pub. No.: US 2023/0242312 A1
(43) Pub. Date: Aug. 3, 2023

(54) COMPOSITE PACKAGE WITH MINERAL OIL BARRIER

(71) Applicant: AMCOR FLEXIBLES NORTH AMERICA, INC., Neenah, WI (US)

(72) Inventors: Florian CHAPALAIN, Marcq-en-Baroeul (FR); Peter Ettridge, Worcester (GB)

(21) Appl. No.: 18/011,794

(22) PCT Filed: Jun. 29, 2020
(86) PCT No.: PCT/US2020/040156

§ 371 Date: Dec. 20, 2022

(51) Int. Cl. B65D 65/40; B32B 27/30; B32B 27/32; B32B 27/08; B65D 77/06; B65D 77/20; B65D 65/42

(52) U.S. Cl. CPC B65D 65/40; B32B 27/306; B32B 27/32; B32B 27/08; B65D 77/062; B65D 77/20; B65D 65/42; B32B 2255/20; B32B 2255/10; B32B 2307/7376; B32B 2439/06; B32B 2439/70; B32B 2439/80; B32B 2435/02; B32B 2307/7265; B32B 2250/24

(57) ABSTRACT

A composite package includes a first container and a second container. The first container includes a fiber-based component. The second container includes a film component and forms a primary product cavity of composite package. The film component includes a mineral oil barrier and a sealant. The mineral oil barrier includes a polymeric film, an inorganic oxide coating, and a layer. The inorganic oxide coating is located on the polymeric film. The layer includes a vinyl alcohol polymer. The vinyl alcohol polymer is located on a surface of the inorganic oxide coating.

### TECHNICAL FIELD

The present application relates generally to composite packages, and in particular to a composite package including a mineral oil barrier.

### BACKGROUND

Various types of composite packages are known in the art for storing products. An example of a composite package includes a bag-in-box type of packaging. The bag-in-box type of packaging includes a bag usually made of several layers of polymers and other materials, seated inside a box made of recycled material, such as recycled paper, cardboard, or corrugated board. As a result of the recycling process, the box often contains mineral oil mixtures and mineral oil-containing products. The mineral oil mixtures present in the box may migrate through the bag to the products. Products in the bag can therefore be exposed to the mineral oil mixtures, which may lead to contamination of the products.

Conventionally, a packaging film with a polyethylene terephthalate (PET) or aluminum layer is provided in order to avoid migration of the mineral oil mixtures and the mineral oil-containing products through the packaging film laminate of the bag. Due to the polar nature of PET, the PET layer provides a migration barrier for mineral oils and mineral oil derivatives.

However, use of such a PET mineral oil barrier layer in a polyolefin-based packaging film may result in difficulties and/or increased expense in recycling the waste generated due to such packaging films after use of the composite packages.

### SUMMARY

A composite package has been developed which includes a mineral oil barrier to prevent migration of mineral oil substances to a product disposed within the composite package whilst retaining an ostensibly mono-polyolefin based formulation, conducive to recycling. The composite package may be used for the storage and transportation of the products. The composite package includes a first container and a second container seated inside the first container. The second container receives the product therein. The first container may be made of a recycled material including mineral oils as residues from its previous life which are not eliminated by the recycling/repulping process. The mineral oils may be highly migratory and may potentially cause a mineral oil contamination of the products disposed within the second container. Such mineral oil contamination may therefore pose an additional risk to the safety of the product. The second container includes a film component which provides an effective mineral oil barrier and prevents or mitigates mineral oil contamination of the product.

One embodiment of the present disclosure is a composite package including a first container and a second container. The first container includes a fiber-based component. The second container includes a film component. Further, the second container forms a primary product cavity of the composite package. The film component includes a mineral oil barrier and a sealant. The mineral oil barrier includes a polymeric film, an inorganic oxide coating, and a layer including a vinyl alcohol polymer. The inorganic oxide coating is located on the polymeric film. The vinyl alcohol polymer is located on a surface of the inorganic oxide coating.

In some embodiments, the vinyl alcohol polymer is between the polymeric film and the inorganic oxide coating.

In some embodiments, the inorganic oxide coating is between the polymeric film and the vinyl alcohol polymer.

In some embodiments, the polymeric film includes polyolefin-based polymers.

In some embodiments, the vinyl alcohol polymer is ethylene vinyl alcohol (EVOH) or polyvinyl alcohol (PVOH).

In some embodiments, the layer including the vinyl alcohol polymer has a thickness from 0.5 micron to 2 microns.

In some embodiments, the fiber-based component includes recycled content.

In some embodiments, the fiber-based component includes mineral oil.

In some embodiments, the first container is not hermetically sealed, and the second container is hermetically sealed.

In some embodiments, the second container is contained within the first container.

In some embodiments, the first container is a box, and the second container is a bag.

In some embodiments, the second container further includes a tray and the film component is a lid sealed to the tray.

In some embodiments, the first container is connected to the second container.

In some embodiments, the inorganic oxide coating includes silicon oxide or aluminum oxide.

In some embodiments, the inorganic oxide coating has a thickness from 6 nm to 200 nm.

In some embodiments, the sealant is non-scalping.

In some embodiments, the composite package further includes a food product or a pharmaceutical product located in the primary product cavity.

In some embodiments, the second container includes at least 80% polyolefin polymers, by weight.

In some embodiments, the second container includes at least 90% polyolefin polymers, by weight.

In some embodiments, the second container is free of polyester films.

Another embodiment of the present disclosure is a composite package including a first container and a hermetically sealed second container. The first container includes a fiber-based component including recycled content. The second container includes a film component. Further, the second container forms a primary product cavity of the composite package. The film component includes a mineral oil barrier and a sealant. The mineral oil barrier includes an oriented polyolefin-based polymeric film, a layer including ethylene vinyl alcohol (EVOH), and an inorganic oxide coating. The layer including EVOH is located on the surface of the polymeric film and a thickness from 0.5 micron to 2 microns. The inorganic oxide coating is located on the surface of the layer including vinyl alcohol polymer.

There are several aspects of the present subject matter which may be embodied separately or together. These aspects may be employed alone or in combination with other aspects of the subject matter described herein, and the description of these aspects together is not intended to preclude the use of these aspects separately or the claiming of such aspects separately or in different combinations.

### BRIEF DESCRIPTION OF THE DRAWINGS

The disclosure may be more completely understood in consideration of the following detailed description of various embodiments of the disclosure in connection with the accompanying drawings, in which:

FIG. 1 is a cross-sectional view of an exemplary composite package;

FIG. 2A illustrates a cross-sectional view of an exemplary film component;

FIG. 2B illustrates a cross-sectional view of another exemplary film component;

FIG. 2C illustrates a cross-sectional view of another exemplary film component;

FIG. 3 is a schematic perspective view of another composite package;

FIG. 4 is a schematic perspective view of another composite package;

FIG. 5 is a schematic perspective view of yet another composite package; and

FIG. 6 is an exemplary graph depicting percentage breakthrough of different packaging laminates.

The figures are not necessarily to scale. Like numbers used in the figures refer to like components. It will be understood, however, that the use of a number to refer to a component in a given figure is not intended to limit the component in another figure labeled with the same number.

### DETAILED DESCRIPTION

The present application describes a composite package including a first container and a second container. The first container includes a fiber-based component. The second container includes a film component. The second container forms a primary product cavity of the composite package. The film component includes a mineral oil barrier and a sealant. The mineral oil barrier includes a polymeric film, an inorganic oxide coating, and a layer including a vinyl alcohol polymer.

The film component of the second container may be free of polyester films. Polyester films are generally used in conventional mineral oil barriers. However, such polyester films may pose difficulties in recycling. The polymeric film used in the film component of the present disclosure may be more acceptable for recycling processes than polyester films. For example, the polymeric film of the present disclosure may include polyolefin-based polymers to facilitate recycling. However, the polymeric film may be a poor barrier to mineral oil. Further, the inorganic oxide coating and the layer including the vinyl alcohol polymer may individually provide limited blocking of mineral oil. However, a combination of the polymeric film, the inorganic oxide coating and the layer including the vinyl alcohol polymer may provide a highly effective mineral oil barrier. Incorporating multiple layers in a barrier film generally results in an additive effect of the barrier properties of the individual layers. The combination of the polymeric film, the inorganic oxide coating and the layer including the vinyl alcohol polymer exhibit barrier performance better than a mere additive effect of the combination. Therefore, the combination of the polymeric film, the inorganic oxide coating and the layer including the vinyl alcohol polymer provide an effective mineral oil barrier to prevent the migration of mineral oil that may be present in the first container to a product disposed within the second container.

Further, the mineral oil barrier of the present disclosure may be transparent and allow X-ray metal detection of a packed product. Thereby, the mineral oil barrier of the present disclosure may provide better product safety credentials than conventional mineral oil barriers, such as aluminum foil barriers and vacuum deposited metallized barrier layers.

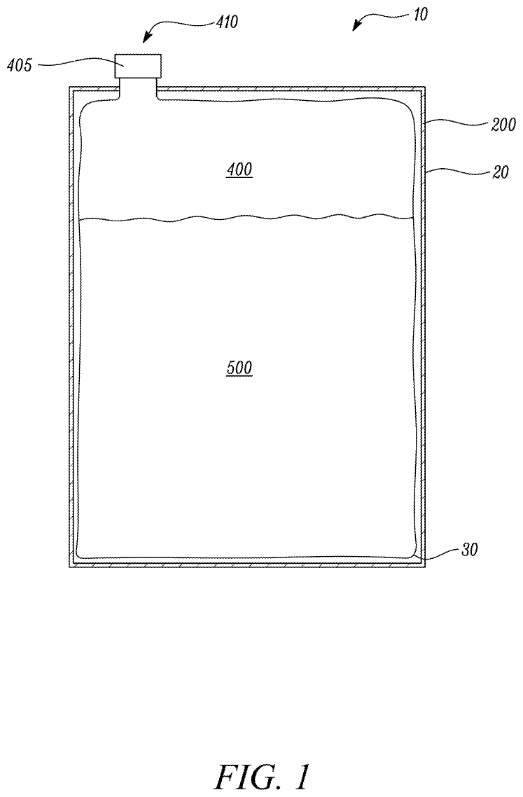

FIG. 1 is a cross-sectional view of a composite package 10. Composite package 10 has a substantially rectangular cross-section. However, in some cases, composite package 10 may have a non-rectangular shape or cross-section, for example, composite package 10 may be hexagonal, octagonal, polygonal, curved, and so forth. The shape of composite package 10 may be based on application requirements. In some embodiments, composite package 10 may be a corrugated shipping box holding several packaged goods. In some other embodiments, composite package 10 may be a bag-in-box package used for packaging of one or more products, such as wine, ketchup, cereal, milk powder, infant food, etc. In some other embodiments, composite package 10 may be a box containing several packs, such as multipacks of baby food. In some other embodiments, composite package 10 may be a paperboard sleeve over a cup and lid package. In some other embodiments, composite package 10 may be a paper based outer wrapper with an inner liner used for products, for example, products packed with vacuum packing. In some other embodiments, composite package 10 may be a spiral wound composite can with an inner liner typically used for food items, such as snack items.

Composite package 10 includes a first container 20 and a second container 30. Second container 30 forms a primary product cavity 400 of composite package 10. Primary product cavity 400 holds a product 500. In some other embodiments, second container 30 may include multiple product cavities similar to primary product cavity 400. As shown in FIG. 1, second container 30 is contained within first container 20. In some embodiments, second container 30 may not be contained within first container 20.

In some embodiments, first container 20 is connected to second container 30. In some other embodiments, first container 20 may not be connected to second container 30. In some embodiments, first container 20 is not hermetically sealed and second container 30 is hermetically sealed. In some embodiments, first container 20 is a box and second container 30 is a bag. In some other embodiments, second container 30 may be a pouch, a stand-up pouch, a pillow style pouch, a stick pack, a lid on a cup, a lid on a tray, a sachet, or an inner liner.

First container 20 includes a fiber-based component 200. In some embodiments, fiber-based component 200 may have a thickness from 1 micron to 5 millimeters. In some embodiments, fiber-based component 200 may be a box, a sleeve, or an outer wrapper. Fiber-based component 200 may include any packaging component, such as paper, cardboard, paperboard, or corrugated board. In some embodiments, fiber-based component 200 includes recycled content. Therefore, fiber-based component 200 may include a mineral oil. Fiber-based component 200 including recycled content may include mineral oil in the form of printing ink residues. The mineral oil may include Mineral Oil Saturated Hydrocarbons (MOSH) and/or Mineral Oil Aromatic Hydrocarbons (MOAH). The mineral oil may be highly migratory, and therefore may potentially cause a mineral oil contamination to product 500 by migrating from first container 20 through second container 30.

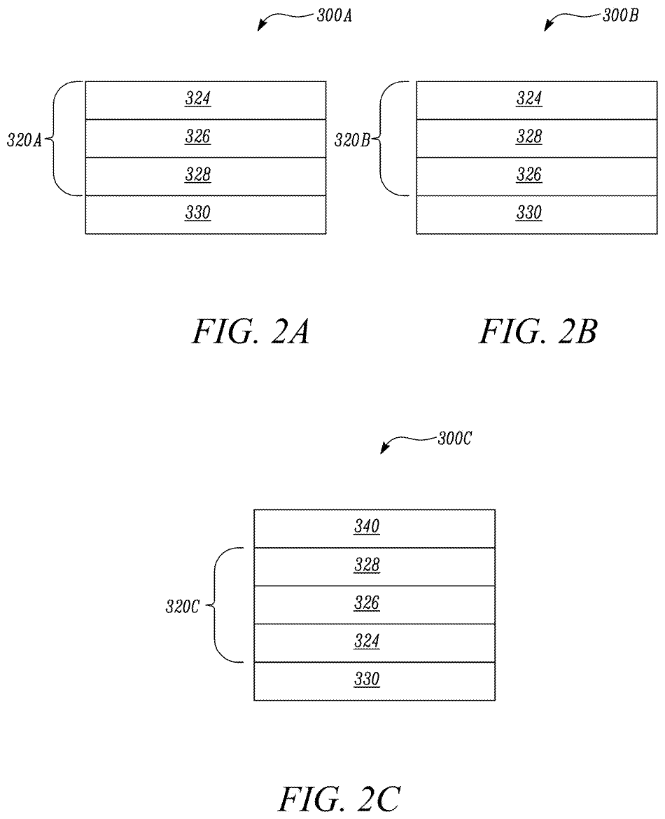

Second container 30 includes a film component. The film component may be any one of film components 300A, 300B, 300C, shown in FIGS. 2A, 2B, 2C, respectively.

In some embodiments, composite package 10 further includes a fitment 410 including a lid 405 which seals product 500 inside primary product cavity 400. In some embodiments, primary product cavity 400 may contain any product 500 that can be dispensed through fitment 410.

Product 500 may be any type of item sensitive to trace amounts of mineral oil. Second container 30 is placed between product 500 and first container 20 to prevent the migration of mineral oil type molecules that may be present in first container 20 to product 500 within second container 30. Prevention of migration of mineral oil type molecules to product 500 may be important due to compliance to regulations and/or taste and odor issues. In some embodiments, composite package 10 includes a food product or a pharmaceutical product located in primary product cavity 400. In other words, product 500 may be a food product or a pharmaceutical product. In some embodiments, composite package 10 includes beverages or nutraceutical products. In some embodiments, primary product cavity 400 may contain liquids, particles, powders, solids, or combinations thereof. The liquids may include, but are not limited to, liquid food items (e.g., juice or wet pet food) or liquid containing industrial items such as cleaning fluids with surfactants. The particles may include particulate products such as pet food products, human food items (e.g., cereal). The powder may include products including, but not limited to, pharmaceuticals, nutritional supplements or powdered food items (e.g., infant formula mix), etc.

FIGS. 2A-2C illustrate cross-sectional view of different film components 300A, 300B, 300C in accordance with different embodiments of the present disclosure. As used herein, the locational descriptor of “on” (i.e. the inorganic oxide coating is on the polymeric film) means that one item is connected to another item, with or without another item between them. As used herein, the location descriptor of “directly adjacent to” means that one item is connected to another item specifically without another item between them (i.e in direct contact with each other).

Each film component 300A, 300B, 300C includes a respective mineral oil barrier 320A, 320B, 320C and a sealant 330. Each mineral oil barrier 320A, 320B, 320C includes a polymeric film 324, an inorganic oxide coating 328 and a layer 326 including a vinyl alcohol polymer.

In some embodiments, polymeric film 324 may be an oriented polyolefin-based polymeric film. Polymeric film 324 may be biaxially or machine direction oriented. In some embodiments, polymeric film 324 includes polyolefin-based polymers. The polyolefin-based polymers may be easy to recycle. In some embodiments, the polyolefin-based polymers may include polyethylene (PE) or polypropylene (PP). In some other embodiments, polymeric film 324 may include a biaxially-oriented polypropylene (BOPP) or a biaxially-oriented polyethylene (BOPE).

In some embodiments, layer 326 including the vinyl alcohol polymer is located on a surface of inorganic oxide coating 328. In some embodiments, layer 326 including the vinyl alcohol polymer is located directly adjacent to a surface of inorganic oxide coating 328. The vinyl alcohol polymer may be a copolymer. In some embodiments, the vinyl alcohol polymer is ethylene vinyl alcohol (EVOH) or a polyvinyl alcohol (PVOH). In some embodiments, the vinyl alcohol polymer may be oriented along with polymeric film 324. In some embodiments, layer 326 including the vinyl alcohol polymer may be directly adjacent to polymeric film 324. In some embodiments, layer 326 including the vinyl alcohol polymer may be coextruded with polymeric film 324, or extrusion coated onto polymeric film 324. In some other embodiments, layer 326 including the vinyl alcohol polymer is coated on polymeric film 324. In some embodiments, layer 326 including the vinyl alcohol polymer has a thickness from 0.5 micron to 2 microns. However, in some other embodiments, layer 326 may have a thickness from 0.2 micron to 3 microns.

In some embodiments, inorganic oxide coating 328 includes silicon oxide or aluminum oxide. Inorganic oxide coating 328 may be applied via vacuum deposition. In some embodiments, inorganic oxide coating 328 is directly adjacent to layer 326. In some embodiments, inorganic oxide coating 328 has a thickness from 6 nanometers (nm) to 200 nm. In some embodiments, inorganic oxide coating 328 may have a thickness of at least 5 nm, at least 10 nm, at least 20 nm, at least 25 nm, or at least 50 nm. In some embodiments, inorganic oxide coating 328 may have a thickness from 20 nm to 100 nm. In some other embodiments, inorganic oxide coating 328 may have a thickness from 30 nm to 80 nm.

Sealant 330 may enable film components 300A, 300B, 300C to be hermetically sealed. Sealing of sealant 330 may be enabled by heat, pressure, ultrasonic acoustic vibrations, or any other known means. Sealant 330 may be polymer based, such as polyethylene copolymers. Sealant 330 may be applied in a pattern, such as a cold seal or a pressure sensitive adhesive material. In some embodiments, sealant 330 is non-scalping. In other words, sealant 330 may include a material that is ultra-clean, such as a polyester or a cyclic olefin copolymer (COC).

FIG. 2A illustrates a cross-sectional view of a film component 300A. Film component 300A includes a mineral oil barrier 320A and sealant 330. Mineral oil barrier 320A includes polymeric film 324, inorganic oxide coating 328 and layer 326 including the vinyl alcohol polymer. Layer 326 including the vinyl alcohol polymer is located on a surface of inorganic oxide coating 328. Inorganic oxide coating 328 is located on polymeric film 324. Specifically, layer 326 including the vinyl alcohol polymer is located on a surface of polymeric film 324 and inorganic oxide coating 328 is located on a surface of layer 326 including the vinyl alcohol polymer. In other words, the vinyl alcohol polymer is disposed between polymeric film 324 and inorganic oxide coating 328. Specifically, layer 326 including the vinyl alcohol polymer is disposed between polymeric film 324 and inorganic oxide coating 328. In some embodiments, layer 326 is directly adjacent to both the polymeric film 324 and the inorganic oxide coating 328. Sealant 330 is applied on another surface of inorganic oxide coating 328 opposite layer 326 including the vinyl alcohol polymer. The sealant 330 may be bonded to the inorganic oxide coating 328 by a layer of adhesive (not shown).

FIG. 2B illustrates a cross-sectional view of another film component 300B. Film component 300B includes a mineral oil barrier 320B and sealant 330. Mineral oil barrier 320B is similar to mineral oil barrier 320A. However, mineral oil barrier 320B has a different arrangement of layers and coatings. Mineral oil barrier 320B includes polymeric film 324, inorganic oxide coating 328 and layer 326.

Inorganic oxide coating 328 is located on a surface of layer 326 including the vinyl alcohol polymer. In some embodiments, inorganic oxide coating 328 is located directly adjacent to polymeric film 324. Specifically, inorganic oxide coating 328 is located on a surface of the polymeric film 324 and layer 326 including the vinyl alcohol polymer is located on a surface of inorganic oxide coating 328. In some embodiments layer 326 is directly adjacent to inorganic oxide coating 328. In other words, inorganic oxide coating 328 is disposed between layer 326 and polymeric film 324. Sealant 330 is applied on a surface of layer 326. The sealant 330 may be bonded to layer 326 by a layer of adhesive (not shown).

FIG. 2C illustrates a cross-sectional view of another film component 300C. Film component 300C includes a mineral oil barrier 320C, sealant 330 and a functional layer 340. Mineral oil barrier 320C also includes polymeric film 324, inorganic oxide coating 328 and layer 326 including the vinyl alcohol polymer. Layer 326 including the vinyl alcohol polymer is located on a surface of inorganic oxide coating 328 and polymeric film 324 is located on a surface of layer 326 including the vinyl alcohol polymer. In other words, layer 326 including the vinyl alcohol polymer is disposed between inorganic oxide coating 328 and polymeric film 324. Further, mineral oil barrier 320C is disposed between functional layer 340 and sealant 330. Sealant 330 is applied on a surface of polymeric film 324 opposite to layer 326 including the vinyl alcohol polymer. The sealant 330 may be bonded to film 324 by a layer of adhesive (not shown). Functional layer 340 may be an oriented or non-oriented polyolefin-based polymeric film, for example, an oriented polypropylene (OPP) film or a BOPP film. Functional layer 340, such as an OPP film or a BOPP film, may be used for food packaging, flower wrapping and labels. Functional layer 340 may be a protective layer to provide stiffness and rigidity to film component 300C. In other words, functional layer 340 may be added to provide other characteristics, for instance durability, stiffness, or rigidity to film component 300C. In some embodiments, functional layer 340 may be a printed layer.

In some embodiments, functional layer 340 may also be added to film components 300A, 300B (shown in FIGS. 2A and 2B). Functional layer 340 may be attached to film components 300A, 300B, 300C using an adhesive (not shown). A number of functional layers 340 that may be added to film components 300A, 300B, 300C may be based on application requirements.

Referring to FIG. 1, second container 30 may include at least 80% polyolefin polymer, by weight. In some other embodiments, second container 30 may include at least 90% polyolefin polymer, by weight. In some embodiments, second container 30 may be at least 80% or 90% polyethylene, by weight. In some other embodiments, second container 30 may be at least 80% or 90% polypropylene, by weight. In some embodiments, second container 30 is free of polyester films.

The polyester films may provide a high barrier to mineral oil contamination, but may not be recyclable. Conversely, polymeric film 324 including the polyolefin-based polymers, such as PE and PP, may be more acceptable for recycling processes than the polyester films. Polymeric film 324 including the polyolefin-based polymers may be individually a poor barrier to the mineral oil. Further, inorganic oxide coating 328 and layer 326 including the vinyl alcohol polymer may individually provide limited blocking of the mineral oil. However, a combination of polymeric film 324, inorganic oxide coating 328 and layer 326 including the vinyl alcohol polymer provides an effective mineral oil barrier. Specifically, the combination of polymeric film 324, inorganic oxide coating 328 and layer 326 including the vinyl alcohol polymer may exhibit barrier performance that is superior to a mere additive effect of the combination. The combination of polymeric film 324, inorganic oxide coating 328 and layer 326 including the vinyl alcohol polymer may therefore provide an effective mineral oil barrier to prevent the migration of the mineral oil that may be present in first container 20 to product 500 within second container 30.

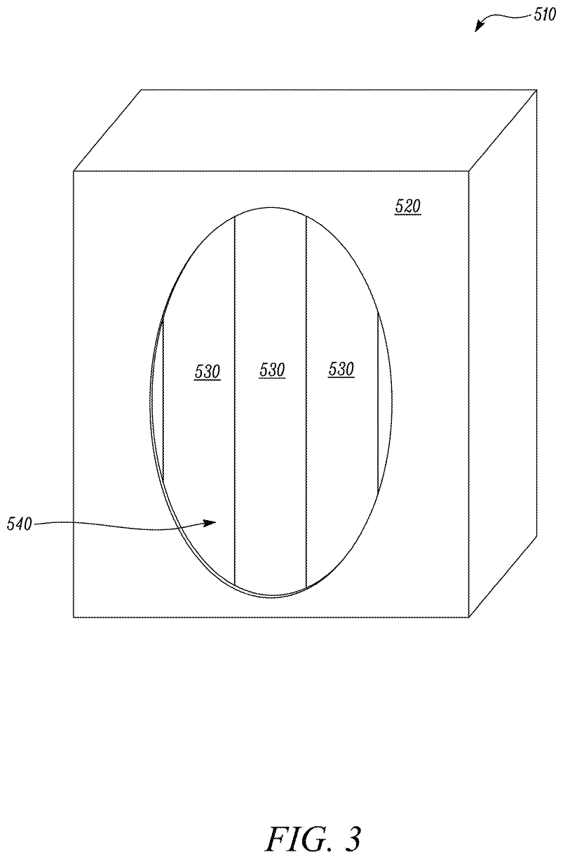

FIGS. 3, 4 and 5 illustrate schematic plan views of different composite packages 510, 610, 710, respectively.

Referring to FIG. 3, composite package 510 is a box containing several stick packs. Composite package 510 includes a first container 520 and multiple second containers 530 equivalent to first container 20 and second container 30 of FIG. 1, respectively. However, composite package 510 has different configurations of first container 520 and second containers 530. In the illustrated embodiment of FIG. 3, first container 520 is the box which holds multiple second containers 530, such as stick packs. Second containers 530 may be suitable for food packaging and may provide a convenient, single-serve, portable package for on-the-go consumers. Second containers 530 may store a product (not shown), such as baby formula mix. Second containers 530 may include multiple variants of a single product or multiple products in composite package 510. Second containers 530 may be available in multiple sizes. Second containers 530 may be sealed on two shorts ends. In some embodiments, second containers 530 may also have a seal (not shown) along a rear side. In some embodiments, each second container 530 includes one of film components 300A, 300B, 300C shown in FIGS. 3A, 3B, 3C, respectively.

First container 520 may include a fiber-based component. The fiber-based component may include paper, cardboard, paperboard, or corrugated board. The fiber-based component may have a thickness from 1 micron to 5 millimeters. First container 520 may include mineral oils from printing inks in recycled fiber-based component. First container 520 further includes a window 540. In the illustrated embodiment of FIG. 3, window 540 is an oval shaped cut-out disposed in first container 520. In some embodiments, window 540 may be covered with a transparent polymer sheet to allow visual inspection of contents inside first container 520. In some embodiments, the transparent polymer sheet may be recyclable. In some other embodiments, the transparent polymer sheet may not be recyclable. In some other embodiments, window 540 may not be covered. In some other embodiments, window 540 may have a circular, a triangular, a rectangular, a pentagonal, a hexagonal, an octagonal, a polygonal, a curved, or an irregular shape, based on application requirements.

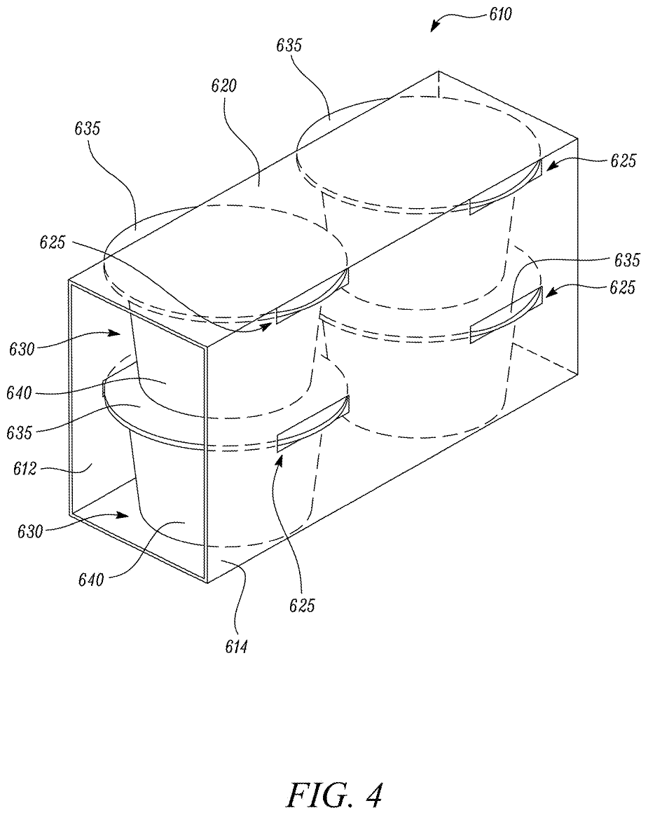

Referring to FIG. 4, composite package 610 is a sleeve wrapped around several cups. Composite package 610 includes a first container 620 and multiple second containers 630 equivalent to first container 20 and second container 30 of FIG. 1, respectively. However, composite package 610 has different configurations of first container 620 and second containers 630. In the illustrated embodiment of FIG. 4, first container 620 is a sleeve which holds multiple second containers 630, such as cups. Composite package 610 may be used for packaging of dairy products, such as yogurt, frozen desserts, etc.

First container 620 includes openings 625. Each opening 625 has a rectangular shape. In other embodiments, openings 625 may have an alternative shape that may be circular, elliptical, polygonal or any irregular shape. First container 620 includes a first wall 612 and an opposing second wall 614. Both first and second walls 612, 614 are side walls of first container 620. In the illustrated embodiments, each of first and second walls 612, 614 includes four openings 625 corresponding to four second containers 630. In the illustrated embodiment of FIG. 4, first container 620 is open from two opposite ends.

Second containers 630 may be suitable for food packaging and may provide a convenient, single-serve, portable package for on-the-go consumers. Second containers 630 may store a product (not shown), such as yogurt, frozen dessert, or ice-cream. Second containers 630 may include multiple variants of a single product or multiple products in composite package 610. Each second container 630 includes a lid 635 and a cup body 640. Each second container 630 includes one of film components 300A, 300B, 300C shown in FIGS. 3A, 3B, 3C, respectively. In some embodiments, film components 300A, 300B or 300C is included in lid 635 of second container 630. In some embodiments, film components 300A, 300B or 300C is included in cup body 640 of second container 630. In some embodiments, film components 300A, 300B or 300C is included in both lid 635 and cup body 640 of second container 630. Lid 635 of each second container 630 partially passes through a corresponding pair of openings 625 of first container 620 so that each second container 630 is removably secured to first container 620.

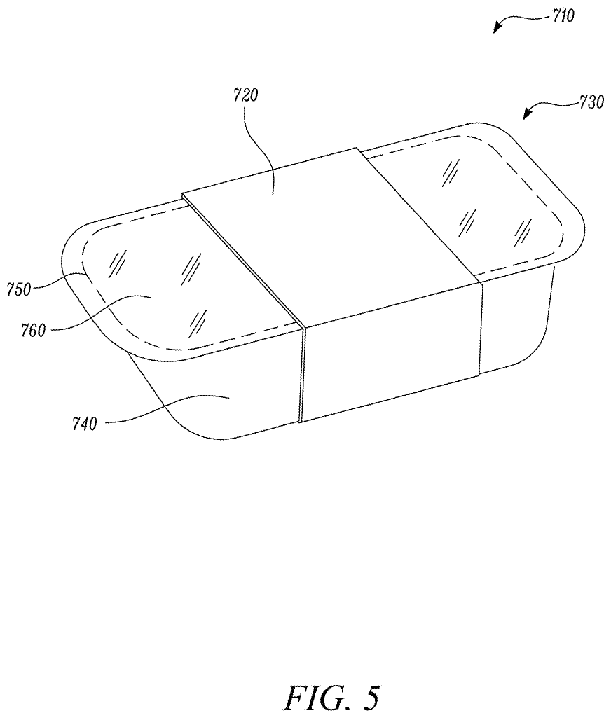

Referring to FIG. 5, composite package 710 is a tray having a fiber-based sleeve. Composite package 710 includes a first container 720 and a second container 730 equivalent to first container 20 and second container 30 of FIG. 1, respectively. However, composite package 710 has different configurations of first container 720 and second container 730. In the illustrated embodiment of FIG. 5, first container 720 is a fiber-based sleeve which wraps around second container 730. First container 720 may include a material, such as paper, cardboard, paperboard, or corrugated board.

Second container 730 may slide-in or slide-out of first container 720. Second container 730 includes a tray portion 740 and a lid 760. Second container 730 may be attached to first container 720, for example, by a small portion of hot tack adhesive (not shown). Tray portion 740 includes a rectangular shape. However, tray portion 740 may have a shape that may be circular, elliptical, polygonal or any irregular shape. In some embodiments, one of film components 300A, 300B, 300C (shown in FIGS. 2A-2C) is lid 760 sealed to tray portion 740. In other embodiments, one of film components 300A, 300B, 300C may alternatively or additionally be tray portion 740.

Lid 760 is sealed to tray portion 740 by a seal 750. Seal 750 may be a heat seal, a cold seal, or a pressure sensitive seal. Composite package 710 may be used for packaging of ready-to-eat food items.

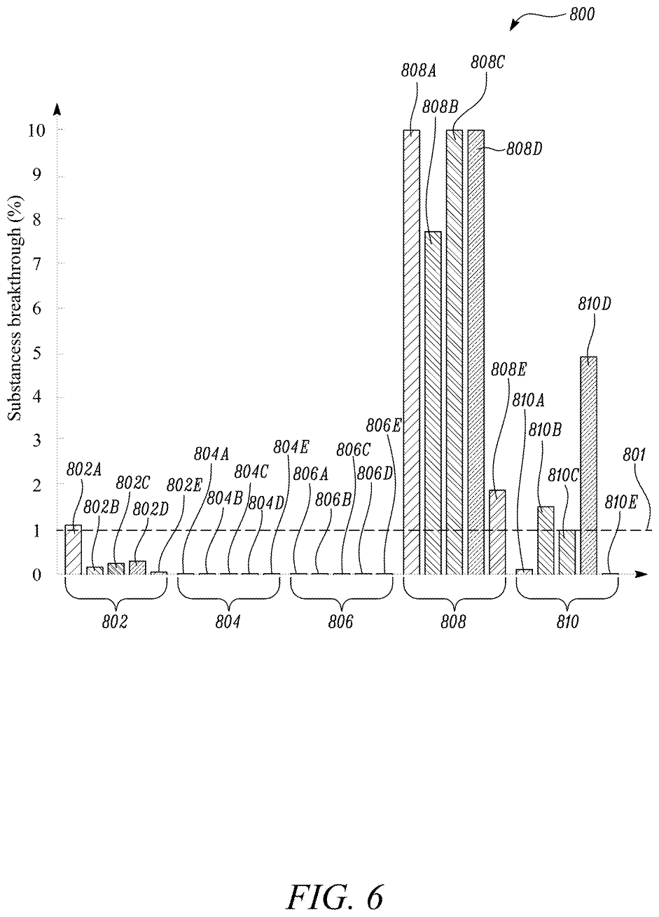

FIG. 6 is an exemplary graph 800 illustrating percentage breakthrough of surrogate substances to mineral oils through different packaging laminates. In other words, graph 800 demonstrates performance of barrier layers of different packaging laminates in the ability to block mineral oil compounds. Graph 800 is valid for long term storage for dry products at ambient conditions.

A first packaging laminate 802, a second packaging laminate 804, a third packaging laminate 806, a fourth packaging laminate 808 and a fifth packaging laminate 810 were prepared and used to evaluate and demonstrate the individual performance of barrier layers of first packaging laminate 802, second packaging laminate 804, third packaging laminate 806, fourth packaging laminate 808 and fifth packaging laminate 810.

Several different packaging laminates were placed between a donor, such as a spiked and conditioned cardboard, and an acceptor, such as Tenax®. Tenax® is generally used as a simulant for dry foods. Each sample including a donor, a packaging laminate, and an acceptor was then wrapped in an aluminum foil and stored in a heat chamber for 10 days at 60 degree Celsius. The testing was otherwise done according to the “Guideline for the assessment of MOSH/MOAH migration from packaging into food with the aim of minimization” published by the German Federation of Food Law and Food Science (BLL e. V.) 2^{nd} ed. February 2019.

After the storage period, the Tenax® was extracted with hexane and analyzed by a gas chromatography (GC) and mass spectrometry (MS) for obtaining the percentage migration or breakthrough of substances, such as MOSH-markers, MOAH-markers, etc. from different packaging laminates. The MOSH-markers and the MOAH-markers include Heptadecane (C17), Methylbenzophenon (MBP), Dipropyphthalate (DPP), Anthracene and Perylene.

Each sample was assessed for barrier to the spiked compounds. A barrier is sufficiently impervious if the breakthrough is below 1% compared to the starting concentration.

Graph 800 includes the percentage breakthrough of C17, MBP, DPP, Anthracene and Perylene, respectively, from each packaging laminate. Graph 800 further includes a breakthrough borderline 801 at 1% breakthrough of the substances (C17, MBP, DPP, Anthracene and Perylene). The percentage breakthrough of the substances from any packaging laminate under breakthrough borderline 801 is considered to be acceptable and that packaging laminate is considered as a good mineral oil barrier.

Referring to FIG. 6, for a given packaging laminate, a breakthrough ending with the letter ‘A’ refers to a breakthrough for C17, a breakthrough ending with the letter ‘B’ refers to a breakthrough for MBP, a breakthrough ending with the letter ‘C’ refers to a breakthrough for DPP, a breakthrough ending with the letter ‘D’ refers to a breakthrough for Anthracene, and a breakthrough ending with the letter ‘E’ refers to a breakthrough for Perylene.

First packaging laminate 802 included a layer of polyethylene terephthalate (PET) having a thickness of 12 microns and a layer of PE having a thickness of 75 microns. First packaging laminate 802 may be referred to as a control laminate. A percentage C17 breakthrough 802A of first packaging laminate 802 slightly exceeded breakthrough borderline 801. A percentage MBP breakthrough 802B, a percentage DPP breakthrough 802C, a percentage Anthracene breakthrough 802D, and a percentage Perylene breakthrough 802E of first packaging laminate 802 was below breakthrough borderline 801, but had non-zero values.

Second packaging laminate 804 is an embodiment of the invention and has a structure of 20 micron OPP/adhesive/50 nm SiOx/1 micron EVOH/17 micron OPP/adhesive/60 micron PE sealing layer. Second packaging laminate 804 displayed a percentage C17 breakthrough 804A, a percentage MBP breakthrough 804B, a percentage DPP breakthrough 804C, a percentage Anthracene breakthrough 804D, and a percentage Perylene breakthrough 804E below breakthrough borderline 801. Specifically, percentage C17 breakthrough 804A, percentage MBP breakthrough 804B, percentage DPP breakthrough 804C, percentage Anthracene 804D breakthrough, and percentage Perylene breakthrough 804E of second packaging laminate 804 was about 0%.

Third packaging laminate 806 is an embodiment of the invention and included a first layer and a second layer. The first layer had a thickness of about 18 microns. The first layer included a layer including OPP and a layer including EVOH on a surface of the layer including OPP. The layer including OPP had a thickness of 17 microns and the layer including EVOH had a thickness of 1 micron. The first layer was further coated with 50 nm of silicon oxide (SiOx). SiOx was applied on the layer including EVOH. The second layer was a layer of OPP having a thickness of 30 microns. Third packaging laminate 806 displayed a percentage C17 breakthrough 806A, a percentage MBP breakthrough 806B, a percentage DPP breakthrough 8060, a percentage Anthracene breakthrough 806D, and a percentage breakthrough Perylene 806E below breakthrough borderline 801. Specifically, percentage C17 breakthrough 806A, percentage MBP breakthrough 806B, percentage DPP breakthrough 806C, percentage Anthracene breakthrough 806D, and percentage Perylene breakthrough 806E of third packaging laminate 806 was about 0%.

Fourth packaging laminate 808 included a first layer and a second layer. The first layer was a coextruded OPP having a thickness of about 18 microns coated and coated with 50 nm of SiOx. The second layer included OPP having a thickness of 30 microns. A percentage C17 breakthrough 808A, a percentage MBP breakthrough 808B, a percentage DPP breakthrough 808C, a percentage Anthracene breakthrough 808D, and a percentage Perylene breakthrough 808E of fourth packaging laminate 808 exceeded breakthrough borderline 801. Specifically, percentage C17 breakthrough 808A was about 21%. Percentage MBP breakthrough 808B was between 7% and 8%. Percentage DPP breakthrough 808C was about 21%. Percentage Anthracene breakthrough 808D was also about 10 percent. Percentage Perylene breakthrough 808E was about 2%.

Fifth packaging laminate 810 included a first layer and a second layer laminated together. The first layer included OPP and EVOH. The first layer had a thickness of about 18 microns. The second layer included PP. A percentage C17 breakthrough 810A, and a percentage Perylene breakthrough 810E of fifth packaging laminate 810 was below breakthrough borderline 801. A percentage DPP breakthrough 810C of fifth packaging laminate 810 was at breakthrough borderline 801. However, a percentage MBP breakthrough 810B and a percentage Anthracene breakthrough 810D exceeded breakthrough borderline 801.

Second and third packaging laminates 804, 806 including OPP, EVOH and SiOx had 0% breakthrough of the substances, such as C17, MBP, DPP, Anthracene, and Perylene. Second and third packaging laminates 804, 806 provided a mineral oil blocking effectiveness better than just the additive effect of combining OPP, EVOH and SiOx, and therefore acted as effective mineral oil barriers.

Further, barrier performance of each of second and third packaging laminates 804, 806 was also better than first laminate 802 including PET and PE. Moreover, second and third packaging laminates 804, 806 may have improved recyclability as compared to first laminate 802 including PET.

### EMBODIMENTS

A. A composite package comprising:
a first container comprising a fiber-based component, and
a second container comprising a film component, the second container forming a primary product cavity of the composite package, the film component comprising a mineral oil barrier and a sealant, characterized in that the mineral oil barrier comprises:
   i) a polymeric film,
   ii) an inorganic oxide coating, the inorganic oxide coating located on the polymeric film, and
   iii) a layer comprising a vinyl alcohol polymer, the vinyl alcohol polymer located on a surface of the inorganic oxide coating.

B. The composite package according to embodiment A wherein the vinyl alcohol polymer is between the polymeric film and the inorganic oxide coating.

C. The composite package according to embodiment A wherein the inorganic oxide coating is between the polymeric film and the vinyl alcohol polymer.

D. The composite package according to any previous embodiment wherein the polymeric film comprises polyolefin-based polymers.

E. The composite package according to any previous embodiment wherein the vinyl alcohol polymer is ethylene vinyl alcohol (EVOH) or polyvinyl alcohol (PVOH).

F. The composite package according to any previous embodiment wherein the layer comprising the vinyl alcohol polymer has a thickness from 0.5 micron to 2 microns.

G. The composite package according to any previous embodiment wherein the fiber-based component comprises recycled content.

H. The composite package according to any previous embodiment wherein the fiber-based component comprises mineral oil.

I. The composite package according to any previous embodiment wherein the first container is not hermetically sealed, and the second container is hermetically sealed.

J. The composite package according to any previous embodiment wherein the second container is contained within the first container.

K. The composite package according to any embodiment A through J wherein the first container is a box and the second container is a bag.

L. The composite package according to any embodiment A through J wherein the second container further comprises a tray and the film component is a lid sealed to the tray.

M. The composite package according to any previous embodiment wherein the first container is connected to the second container.

N. The composite package according to any previous embodiment wherein the inorganic oxide coating comprises silicon oxide or aluminum oxide.

O. The composite package according to any previous embodiment wherein the inorganic oxide coating has a thickness from 6 nm to 200 nm.

P. The composite package according to any previous embodiment wherein the sealant is non-scalping.

Q. The composite package according to any previous embodiment further comprising a food product or a pharmaceutical product located in the primary product cavity.

R. The composite package according to any previous embodiment wherein the second container comprises at least 80% polyolefin polymers, by weight.

S. The composite package according to any previous embodiment, wherein the second container comprises at least 90% polyolefin polymers, by weight.

T. The composite package according to any previous embodiment wherein the second container is free of polyester films.

U. A composite package comprising:
a first container comprising a fiber-based component comprising recycled content, and
a hermetically sealed second container comprising a film component, the second container forming a primary product cavity of the composite package, the film component comprising a mineral oil barrier and a sealant, characterized in that the mineral oil barrier comprises:
   i) an oriented polyolefin-based polymeric film,
   ii) a layer comprising ethylene vinyl alcohol (EVOH), the layer being located on the surface of the polymeric film and having a thickness from 0.5 micron to 2 microns, and
   iii) an inorganic oxide coating, the inorganic oxide coating being located on the surface of the layer comprising vinyl alcohol polymer.

1. A composite package comprising:
a first container comprising a fiber-based component, and
a second container comprising a film component, the second container forming a primary product cavity of the composite package, the film component comprising a mineral oil barrier and a sealant, characterized in that the mineral oil barrier comprises:
i) a polymeric film,
ii) an inorganic oxide coating, the inorganic oxide coating located on the polymeric film, and
iii) a layer comprising a vinyl alcohol polymer, the vinyl alcohol polymer located on a surface of the inorganic oxide coating.

2. The composite package according to claim 1 wherein the vinyl alcohol polymer is between the polymeric film and the inorganic oxide coating.

3. The composite package according to claim 1 wherein the inorganic oxide coating is between the polymeric film and the vinyl alcohol polymer.

4. The composite package according to claim 1 wherein the polymeric film comprises polyolefin-based polymers.

5. The composite package according to claim 1 wherein the vinyl alcohol polymer is ethylene vinyl alcohol (EVOH) or polyvinyl alcohol (PVOH).

6. The composite package according to claim 1 wherein the layer comprising the vinyl alcohol polymer has a thickness from 0.5 micron to 2 microns.

7. The composite package according to claim 1 wherein the fiber-based component comprises recycled content.

8. The composite package according to claim 1 wherein the fiber-based component comprises mineral oil.

9. The composite package according to claim 1 wherein the first container is not hermetically sealed, and the second container is hermetically sealed.

10. The composite package according to claim 1 wherein the second container is contained within the first container.

11. The composite package according to claim 1 wherein the first container is a box and the second container is a bag.

12. The composite package according to claim 1 wherein the second container further comprises a tray and the film component is a lid sealed to the tray.

13. The composite package according to claim 1 wherein the first container is connected to the second container.

14. The composite package according to claim 1 wherein the inorganic oxide coating comprises silicon oxide or aluminum oxide.

15. The composite package according to claim 1 wherein the inorganic oxide coating has a thickness from 6 nm to 200 nm.

16. (canceled)

17. The composite package according to claim 1 further comprising a food product or a pharmaceutical product located in the primary product cavity.

18. The composite package according to claim 1 wherein the second container comprises at least 80% polyolefin polymers, by weight.

19. The composite package according to claim 1, wherein the second container comprises at least 90% polyolefin polymers, by weight.

20. The composite package according to claim 1 wherein the second container is free of polyester films.

21. A composite package comprising:
a first container comprising a fiber-based component comprising recycled content, and
a hermetically sealed second container comprising a film component, the second container forming a primary product cavity of the composite package, the film component comprising a mineral oil barrier and a sealant, characterized in that the mineral oil barrier comprises:
i) an oriented polyolefin-based polymeric film,
ii) a layer comprising ethylene vinyl alcohol (EVOH), the layer being located on the surface of the polymeric film and having a thickness from 0.5 micron to 2 microns, and
iii) an inorganic oxide coating, the inorganic oxide coating being located on the surface of the layer comprising vinyl alcohol polymer.
